(19) United States
(12) Patent Application Publication
(10) Pub. No.: US 2025/0008375 A1
(43) Pub. Date: Jan. 2, 2025

(54) SYSTEMS AND METHODS FOR REAL-TIME LOAD BALANCING OF WIRELESS DATA TRANSMISSIONS

(71) Applicant: Mixhalo Corp., San Francisco, CA (US)

(72) Inventor: Vikram Singh, San Francisco, CA (US)

(21) Appl. No.: 18/760,224

(22) Filed: Jul. 1, 2024

Related U.S. Application Data
(60) Provisional application No. 63/524,488, filed on Jun. 30, 2023.

(51) Int. Cl. H04W 28/086; H04W 84/12

(52) U.S. Cl. CPC H04W 28/086; H04W 84/12

(57) ABSTRACT

A method for real-time delivery of live event data to a first mobile computing device at a live event based on a machine learning algorithm includes receiving a first data representation of a live audio signal via a Wi-Fi network connection. The method also includes receiving a second data representation of the live audio signal via a cellular network connection. The method also includes receiving a third data representation of the live audio signal from a second mobile computing device at the live event via a Bluetooth connection. The method also includes determining whether the first data representation, the second data representation, or the third data representation is being received via an optimal connection using a machine learning algorithm. The method also includes processing the first data representation, the second data representation, or the third data representation into a live audio stream based on the determined optimal connection.

### RELATED APPLICATION(S)

This application claims priority to U.S. Provisional Patent Application No. 63/524,488, filed on Jun. 30, 2023, the entire disclosure of which is incorporated herein by reference.

### FIELD OF THE INVENTION

This invention relates generally to the field of real-time delivery of data, such as audio, over wireless networks. More specifically, the invention relates to systems and methods for load balancing real-time transmission of data over wireless networks based on machine learning.

### BACKGROUND

Attendees of live events often bring and use their mobile computing device to stream data (e.g., audio or video) using at least one of the available wireless networks at the venue (e.g., Wi-Fi® or cellular). However, due to the large number of attendees at live events, data streaming from the available wireless networks at the venue may suffer from an undesirable or unbearable amount of latency and/or instability. The mobile computing device user may manually switch from one available wireless network to another but there is no guarantee that latency or stability will improve after the switch and the data stream may be interrupted. Therefore, there is a need for systems and methods that allow mobile computing devices to automatically switch from one wireless network to another with better conditions without interrupting the data stream.

### SUMMARY

The present invention includes systems and methods for load balancing of real-time delivery of live event data to a mobile computing device at a live event over one or more wireless networks based on a machine learning algorithm. For example, the present invention includes methods and mechanisms for receiving a data representation of a live audio signal corresponding to the live event via a Wi-Fi® network connection. The present invention also includes methods and mechanisms for receiving a data representation of the live audio signal corresponding to the live event via a cellular network. The present invention also includes methods and mechanisms for receiving a data representation of the live audio signal corresponding to the live event via a Bluetooth® connection.

The present invention also includes methods and mechanisms for determining whether the data representation of the live audio signal corresponding to the live event is being received via an optimal connection using a machine learning algorithm. For example, the present invention also includes methods and mechanisms for processing the data representation of the live audio signal corresponding to the live event into a live audio stream based on the determined optimal connection.

In one aspect, the invention includes a computerized method for real-time delivery of live event data over wireless networks based on a machine learning algorithm. The computerized method includes receiving, by a first mobile computing device at a live event, a first data representation of a live audio signal corresponding to the live event via a Wi-Fi network connection. The computerized method also includes receiving, by the first mobile computing device at the live event, a second data representation of the live audio signal corresponding to the live event via a cellular network connection. The computerized method also includes receiving, by the first mobile computing device at the live event, a third data representation of the live audio signal corresponding to the live event from a second mobile computing device at the live event via a Bluetooth connection.

The computerized method also includes determining, by the first mobile computing device at the live event, whether the first data representation of the live audio signal, the second data representation of the live audio signal, or the third data representation of the live audio signal is being received via an optimal connection using a machine learning algorithm. The computerized method also includes processing, by the first mobile computing device at the live event, the first data representation of the live audio signal, the second data representation of the live audio signal, or the third data representation of the live audio signal into a live audio stream based on the determined optimal connection. The computerized method also includes initiating, by the first mobile computing device at the live event, playback of the live audio stream via a headphone communicatively coupled to the first mobile computing device at the live event.

In some embodiments, the computerized method further includes receiving, by the first mobile computing device at the live event, the first data representation of the live audio signal corresponding to the live event from an audio server computing device via the Wi-Fi network connection. In some embodiments, the computerized method further includes receiving, by the first mobile computing device at the live event, the second data representation of the live audio signal corresponding to the live event from an audio server computing device via the cellular network connection.

In some embodiments, receiving, by the first mobile computing device at the live event, the first data representation of the live audio signal corresponding to the live event via the Wi-Fi network connection is associated with a first latency parameter and a first stability parameter. In some embodiments, receiving, by the first mobile computing device at the live event, the second data representation of the live audio signal corresponding to the live event via the cellular network connection is associated with a second latency parameter and a second stability parameter. In some embodiments, receiving, by the first mobile computing device at the live event, the third data representation of the live audio signal corresponding to the live event from the second mobile computing device at the live event via the Bluetooth connection is associated with a third latency parameter and a third stability parameter.

For example, in some embodiments, the first stability parameter corresponds to a first number of packets lost during a time period, the second stability parameter corresponds to a second number of packets lost during the time period, and the third stability parameter corresponds to a third number of packets lost during the time period. In some embodiments, determining, by the first mobile computing device at the live event, whether the first data representation of the live audio signal, the second data representation of the live audio signal, or the third data representation of the live audio signal is being received via the optimal connection using the machine learning algorithm is based on the first latency parameter, the first stability parameter, the second latency parameter, the second stability parameter, the third latency parameter, and the third stability parameter.

In another aspect, the invention includes a first mobile computing device at a live event for real-time delivery of live event data over wireless networks based on a machine learning algorithm. The first mobile computing device at the live event is configured to receive a first data representation of a live audio signal corresponding to the live event via a Wi-Fi network connection. The first mobile computing device at the live event is also configured to receive a second data representation of the live audio signal corresponding to the live event via a cellular network connection. The first mobile computing device at the live event is also configured to receive a third data representation of the live audio signal corresponding to the live event from a second mobile computing device at the live event via a Bluetooth connection.

The first mobile computing device at the live event is also configured to determine whether the first data representation of the live audio signal, the second data representation of the live audio signal, or the third data representation of the live audio signal is being received via an optimal connection using a machine learning algorithm. The first mobile computing device at the live event is also configured to process the first data representation of the live audio signal, the second data representation of the live audio signal, or the third data representation of the live audio signal into a live audio stream based on the determined optimal connection. The first mobile computing device at the live event is also configured to initiate playback of the live audio stream via a headphone communicatively coupled to the first mobile computing device at the live event.

In some embodiments, the first mobile computing device at the live event is further configured to receive the first data representation of the live audio signal corresponding to the live event from an audio server computing device via the Wi-Fi network connection. In some embodiments, the first mobile computing device at the live event is further configured to receive the second data representation of the live audio signal corresponding to the live event from an audio server computing device via the cellular network connection.

In some embodiments, receiving, by the first mobile computing device at the live event, the first data representation of the live audio signal corresponding to the live event via the Wi-Fi network connection is associated with a first latency parameter and a first stability parameter. In some embodiments, receiving, by the first mobile computing device at the live event, the second data representation of the live audio signal corresponding to the live event via the cellular network connection is associated with a second latency parameter and a second stability parameter. In some embodiments, receiving, by the first mobile computing device at the live event, the third data representation of the live audio signal corresponding to the live event from the second mobile computing device at the live event via the Bluetooth connection is associated with a third latency parameter and a third stability parameter.

For example, in some embodiments, the first stability parameter corresponds to a first number of packets lost during a time period, the second stability parameter corresponds to a second number of packets lost during the time period, and the third stability parameter corresponds to a third number of packets lost during the time period. In some embodiments, determining, by the first mobile computing device at the live event, whether the first data representation of the live audio signal, the second data representation of the live audio signal, or the third data representation of the live audio signal is being received via the optimal connection using the machine learning algorithm is based on the first latency parameter, the first stability parameter, the second latency parameter, the second stability parameter, the third latency parameter, and the third stability parameter.

In another aspect, the invention includes a system for real-time delivery of live event data over wireless networks based on a machine learning algorithm. The system includes a first mobile computing device at a live event communicatively coupled to a second mobile computing device at the live event and an audio server computing device over a Bluetooth network, a Wi-Fi network, or a cellular network. The first mobile computing device at the live event is configured to receive a first data representation of a live audio signal corresponding to the live event via a Wi-Fi network connection. The first mobile computing device at the live event is also configured to receive a second data representation of the live audio signal corresponding to the live event via a cellular network connection. The first mobile computing device at the live event is also configured to receive a third data representation of the live audio signal corresponding to the live event from a second mobile computing device at the live event via a Bluetooth connection.

The first mobile computing device at the live event is also configured to determine whether the first data representation of the live audio signal, the second data representation of the live audio signal, or the third data representation of the live audio signal is being received via an optimal connection using a machine learning algorithm. The first mobile computing device at the live event is also configured to process the first data representation of the live audio signal, the second data representation of the live audio signal, or the third data representation of the live audio signal into a live audio stream based on the determined optimal connection. The first mobile computing device at the live event is also configured to initiate playback of the live audio stream via a headphone communicatively coupled to the first mobile computing device at the live event.

In some embodiments, the first mobile computing device at the live event is further configured to receive the first data representation of the live audio signal corresponding to the live event from the audio server computing device via the Wi-Fi network connection. In some embodiments, the first mobile computing device at the live event is further configured to receive the second data representation of the live audio signal corresponding to the live event from the audio server computing device via the cellular network connection.

In some embodiments, receiving, by the first mobile computing device at the live event, the first data representation of the live audio signal corresponding to the live event via the Wi-Fi network connection is associated with a first latency parameter and a first stability parameter. In some embodiments, receiving, by the first mobile computing device at the live event, the second data representation of the live audio signal corresponding to the live event via the cellular network connection is associated with a second latency parameter and a second stability parameter. In some embodiments, receiving, by the first mobile computing device at the live event, the third data representation of the live audio signal corresponding to the live event from the second mobile computing device at the live event via the Bluetooth connection is associated with a third latency parameter and a third stability parameter.

For example, in some embodiments, the first stability parameter corresponds to a first number of packets lost during a time period, the second stability parameter corresponds to a second number of packets lost during the time period, and the third stability parameter corresponds to a third number of packets lost during the time period. In some embodiments, determining, by the first mobile computing device at the live event, whether the first data representation of the live audio signal, the second data representation of the live audio signal, or the third data representation of the live audio signal is being received via the optimal connection using the machine learning algorithm is based on the first latency parameter, the first stability parameter, the second latency parameter, the second stability parameter, the third latency parameter, and the third stability parameter.

In some embodiments, the second mobile computing device is configured to receive the third data representation of the live audio signal corresponding to the live event from the audio server computing device via the Wi-Fi network connection. In other embodiments, the second mobile computing device is configured to receive the third data representation of the live audio signal corresponding to the live event from the audio server computing device via the cellular network connection.

These and other aspects of the invention will be more readily understood from the following descriptions of the invention, when taken in conjunction with the accompanying drawings and claims.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic diagram of a system architecture for real-time delivery of live event data over wireless networks, according to an illustrative embodiment of the invention.

FIG. 2 is a schematic diagram of a system architecture for real-time delivery of live event data over wireless networks based on a machine learning algorithm, according to an illustrative embodiment of the invention.

FIG. 3 is a schematic flow diagram illustrating real-time delivery of live event data over wireless networks based on a machine learning algorithm, according to an illustrative embodiment of the invention.

### DETAILED DESCRIPTION

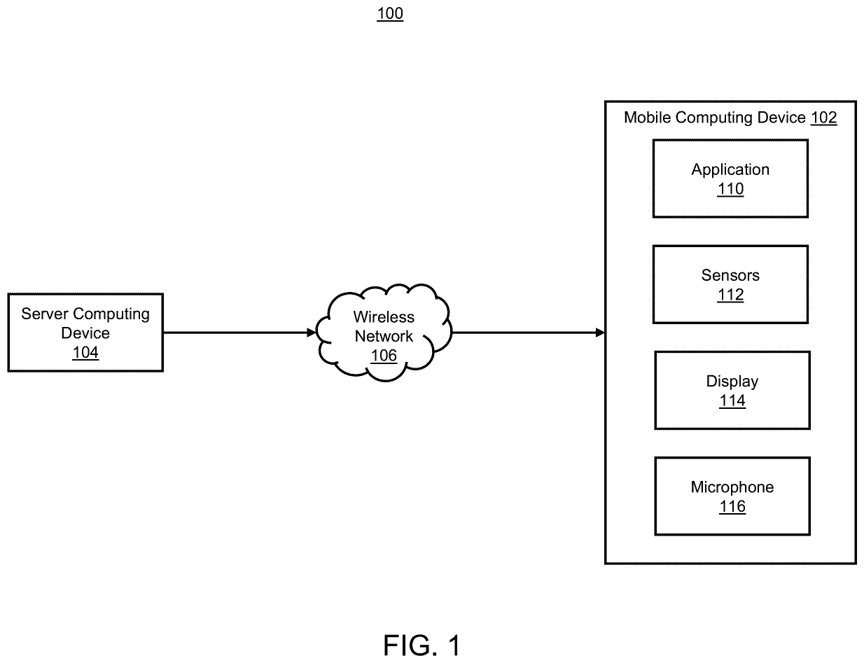

FIG. 1 is a schematic diagram of a system architecture 100 for real-time delivery of live event data over wireless networks, according to an illustrative embodiment of the invention. System 100 includes one or more mobile computing devices 102 communicatively coupled to a server computing device 104 (or audio server computing device) over one or more wireless networks 106. Mobile computing device 102 includes an application 110, one or more speakers 112, one or more displays 114, and one of more microphones 116. In some embodiments, the server computing device 104 is communicatively coupled to an audio interface (not shown).

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of mobile computing devices.

Mobile computing device 102 is configured to receive a data representation of a live audio signal corresponding to the live event via wireless network 106. For example, in some embodiments, mobile computing device 102 is configured to receive the data representation of the live audio signal corresponding to the live event from server computing device 104 via wireless network 106, where server computing device 104 is coupled to an audio source at the live event (e.g., a soundboard that is capturing live audio). Mobile computing device 102 is also configured to process the data representation of the live audio signal into a live audio stream.

Mobile computing device 102 is also configured to initiate playback of the live audio stream via a first headphone (not shown) communicatively coupled to the mobile computing device 102 at the live event. For example, the user of mobile computing device 102 can connect a headphone to the device via a wired connection (e.g., by plugging the headphone into a jack on the mobile computing device) or via a wireless connection (e.g., pairing the headphone to the mobile computing device via a short-range communication protocol such as Bluetooth®). Mobile computing device 102 can then initiate playback of the live audio stream via the headphone.

The systems and methods described herein can be implemented using supervised learning and/or machine learning algorithms. Supervised learning is the machine learning task of learning a function that maps an input to an output based on example of input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples. Generally, machine learning is defined as enabling computers to learn from input data without being explicitly programmed to do so by using algorithms and models to analyze and draw inferences or predictions from patterns in the input data. Typically, the learning process is performed iteratively—e.g., a trained machine learning model analyzes new input data, and the output is compared against expected output to refine the performance of the model. This iterative aspect allows computers to identify hidden insights and repeated patterns and use these findings to adapt when exposed to new data. As can be appreciated, machine learning algorithms and processing can be applied by mobile computing device 102 when analyzing the live audio stream to determine the baseline characteristics. In some embodiments, the machine learning model used to determine the baseline characteristics is a classification model—where the model receives as input certain variables or attributes of the live audio stream during a defined time window (e.g., last 10 seconds) and analyzes the input data to generate a classification or label for the live audio stream during that time window. For input data that aligns with expected baseline characteristics, the model can classify the input data as ‘baseline.’

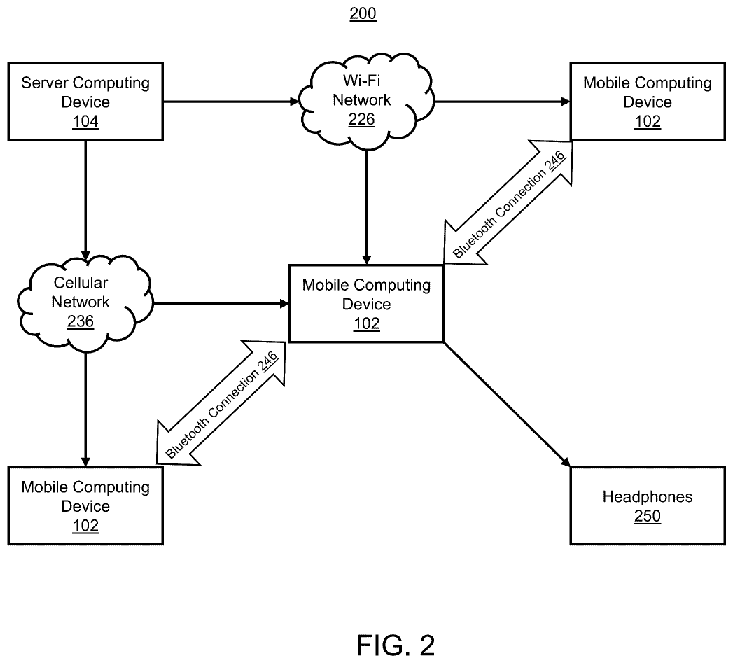

For example, FIG. 2 is a schematic diagram of a system architecture 200 for load balancing of real-time delivery of live event data over wireless networks based on a machine learning algorithm, according to an illustrative embodiment of the invention. System 200 includes a first mobile computing device 102 at a live event communicatively coupled to an audio server computing device 104 over a Wi-Fi® network 226 and/or a cellular network 236. System 200 also includes a second mobile computing device 102 at the live event communicatively coupled to the first mobile computing device 102 over a Bluetooth® connection 246. In some embodiments, system 200 also includes a third mobile computing device 102 at the live event communicatively coupled to the first mobile computing device 102 over a Bluetooth connection 246.

The first mobile computing device 102 at the live event is configured to receive a first data representation of a live audio signal corresponding to the live event via a Wi-Fi® network connection 226. In some embodiments, application 110 of mobile computing device 102 is configured to activate a function to detect one or more Wi-Fi networks that are in range of mobile computing device 102 and establish a connection to one of the in-range Wi-Fi networks. An exemplary application 110 can be an app downloaded to and installed on the mobile computing device 102 via, e.g., the Apple® App Store or the Google® Play Store. A user of mobile computing device 102 can launch application 110 and interact with one or more user interface elements displayed by the application 110 on a screen of the mobile computing device 102. For example, application 110 can display a list of in-range Wi-Fi networks to the user and the user can select a network from the list to establish the Wi-Fi connection. Once the Wi-Fi network connection is established, the first mobile computing device 102 can begin receiving the first data representation of the live audio signal from the server computing device 104 via the Wi-Fi connection.

The first mobile computing device 102 at the live event is also configured to receive a second data representation of the live audio signal corresponding to the live event via a cellular network connection 236. In some embodiments, mobile computing device 102 is configured to include cellular network hardware (e.g., transmitter, antenna, subscriber identity mobile (SIM) card) and software that enables mobile computing device 102 to authenticate and connect to a cellular network. For example, the user may be a customer of a cellular network provider and the first mobile computing device 102 is configured to automatically establish a connection to the provider's cellular network via one or more nearby towers in the network. Application 110 of the first mobile computing device 102 can be configured to use the established cellular network connection to receive the second data representation of the live audio signal from the server computing device 104.

The first mobile computing device 102 at the live event is also configured to receive a third data representation of the live audio signal corresponding to the live event from a second mobile computing device 102 at the live event via a Bluetooth® connection 246. In some embodiments, application 110 of mobile computing device 102 is configured to activate a function to detect one or more Bluetooth-enabled mobile computing devices that are in range of the first mobile computing device 102 and establish a connection to one of the in-range Bluetooth-enabled mobile computing devices. For example, a plurality of users at the live event may each activate the application 110 on their respective mobile computing devices to detect and/or broadcast to nearby user devices via Bluetooth. The first mobile computing device 102 can display a list of nearby devices to the user and the user can select a device from the list to connect to and pair with the selected device. In some embodiments, the Bluetooth connection can be a broadcast (similar to Auracast™ in the Bluetooth® specification (described at bluetooth.com/auracast)) or the Bluetooth connection can be a peer-to-peer link with another mobile device that is “listening” to the same data stream.

In some embodiments, the first mobile computing device 102 at the live event is further configured to receive the first data representation of the live audio signal corresponding to the live event from the audio server computing device 104 via the Wi-Fi network connection 226. In some embodiments, the first mobile computing device 102 at the live event is further configured to receive the second data representation of the live audio signal corresponding to the live event from the audio server computing device 104 via the cellular network connection 236.

In some embodiments, the second or third mobile computing device 102 is configured to receive the third data representation of the live audio signal corresponding to the live event from the audio server computing device 104 via the Wi-Fi® network connection 226. In other embodiments, the second or third mobile computing device 102 is configured to receive the third data representation of the live audio signal corresponding to the live event from the audio server computing device 104 via the cellular network connection 236.

The first mobile computing device 102 at the live event is also configured to determine whether the first data representation of the live audio signal, the second data representation of the live audio signal, or the third data representation of the live audio signal is being received via an optimal connection using a machine learning algorithm. In some embodiments, the first mobile computing device 102 is configured to evaluate one or more quality of service (QOS) parameters based upon characteristics associated with each of the first data representation of the live audio signal, the second data representation of the live audio signal, or the third data representation of the live audio signal. Based on the evaluation of the QoS parameters, the first mobile computing device 102 can determine which connection (e.g., Wi-Fi®, cellular, Bluetooth®) is optimal. In some embodiments, the first mobile computing device 102 can capture quality metrics associated with each connection—such as latency, stability (e.g., by measuring packet loss and/or jitter and comparing them to expected or optimal rates), and/or signal strength. The first mobile computing device 102 can convert the captured quality metrics for each connection into a corresponding vector representation, where the vector representation is comprised of a plurality of feature values that represent the quality metrics for the connection. For example, the first mobile computing device 102 can measure the latency associated with a cellular connection received at the device—that is, the network latency from the device 102 to the base station hardware—as four milliseconds. The first mobile computing device 102 can convert the measured latency into a feature value for inclusion in the vector representation (along with other quality metrics). An exemplary vector representation can include feature values that range from 0 to 1X—e.g., [0.89, 0.44, 0, 0.77, . . . ]. The first mobile computing device 102 can then provide the vector representations for one or more connections established between the device 102 and various wireless networks to a trained machine learning (ML) classification model executing on the device 102. The trained ML model evaluates the vector representation to generate a prediction or label of the connection quality—for example, the output from the trained ML model can comprise a numeric value corresponding to the estimated or predicted quality of the connection based upon the feature values. An exemplary output from the trained ML model can be between 0 and 1—where values closer to 0 represent a low-quality connection while values closer to 1 represent a high-quality connection. In some embodiments, the ML model is trained using a corpus of training data including captured quality metrics (and/or vector representations of such metrics) that have been labeled with a connection quality (e.g., a value between 0 and 1). The ML model is trained to predict connection quality values for previously unknown input data based upon what the model learns by ingesting and evaluating the training data. In some embodiments, the ML model comprises a Long Short Term Memory (LSTM) neural network that generates a binary output label (e.g., HIGH QUALITY, LOW QUALITY) and/or a numeric output value for each vector representation. Further detail on using network quality metrics to evaluate whether a connection is optimal in the context of live video (where such techniques are equally applicable to live audio) is described in S. C. Madanapalli et al., “Modeling Live Video Streaming: Real-Time Classification, QoE Inference, and Field Evaluation,” arXiv: 2112.02637v1 [cs.NI] Dec. 5, 2021, available at arxiv.org/pdf/2112.02637, which is incorporated by reference.

As indicated above, the trained ML model can be included as part of application 110, which generates vector representations for connection quality metrics periodically during receipt of the first data representation of the live audio signal, the second data representation of the live audio signal, and the third data representation of the live audio signal. Application 110 concurrently executes the ML model on a processor of device 102 to classify each vector representation and determine which connection(s) are optimal based upon the quality metrics. Further information regarding implementation of the ML model on the first mobile computing device 102 is described in Y. Wang et al., “A survey on deploying model deep learning applications: A systematic and technical perspective,” Digital Communications and Networks, Vol. 8, Issue 1, February 2022, pp. 1-17, which is incorporated herein by reference.

The first mobile computing device 102 at the live event is also configured to process the first data representation of the live audio signal, the second data representation of the live audio signal, or the third data representation of the live audio signal into a live audio stream based on the determined optimal connection.

In some embodiments, receiving, by the first mobile computing device 102 at the live event, the first data representation of the live audio signal corresponding to the live event via the Wi-Fi® network connection 226 is associated with a first latency parameter and a first stability parameter. In some embodiments, receiving, by the first mobile computing device 102 at the live event, the second data representation of the live audio signal corresponding to the live event via the cellular network connection 236 is associated with a second latency parameter and a second stability parameter. In some embodiments, receiving, by the first mobile computing device 102 at the live event, the third data representation of the live audio signal corresponding to the live event from the second mobile computing device 102 at the live event via the Bluetooth® connection 246 is associated with a third latency parameter and a third stability parameter.

For example, in some embodiments, the first stability parameter corresponds to a first number of packets lost during a time period, the second stability parameter corresponds to a second number of packets lost during the time period, and the third stability parameter corresponds to a third number of packets lost during the time period. In some embodiments, determining, by the first mobile computing device 102 at the live event, whether the first data representation of the live audio signal, the second data representation of the live audio signal, or the third data representation of the live audio signal is being received via the optimal connection using the machine learning algorithm is based on the first latency parameter, the first stability parameter, the second latency parameter, the second stability parameter, the third latency parameter, and the third stability parameter.

It should be appreciated that, in some embodiments, the first mobile computing device 102 is configured to automatically switch between different network connections based upon periodic evaluation of the connection quality metrics as described above. For example, at a first time t1, the first mobile computing device 102 can capture quality metrics (e.g., latency parameter, stability parameter) associated with each of the connections over which the first data representation, second data representation, and third data representation are being received. The first mobile computing device 102 can utilize the trained ML model as described above to determine which connection is optimal based upon the quality metrics. In this example, the first mobile computing device 102 can determine that the Wi-Fi connection is optimal (e.g., due to low latency and high stability) and receive the first representation of the live audio signal using the Wi-Fi connection. However, over time as more users connect their mobile devices to the Wi-Fi network, the connection quality may degrade. At a second time t2, the first mobile computing device 102 again captures quality metrics (e.g., latency parameter, stability parameter) associated with each of the connections over which the first data representation, second data representation, and third data representation are being received and utilizes the trained ML model to determine that the cellular connection is now the most optimal connection in view of the quality metrics. Upon making this determination, the first mobile computing device 102 can automatically switch to begin receiving the second representation of the live audio signal over the cellular connection-thereby providing uninterrupted, high-quality receipt and processing of the live audio signal.

The first mobile computing device 102 at the live event is also configured to initiate playback of the live audio stream via a headphone 250 communicatively coupled to the first mobile computing device 102 at the live event. In some embodiments, the first mobile computing device 102 at the live event is also configured to initiate playback of the live audio stream via the one or more speakers 112 of the first mobile computing device 102 at the live event.

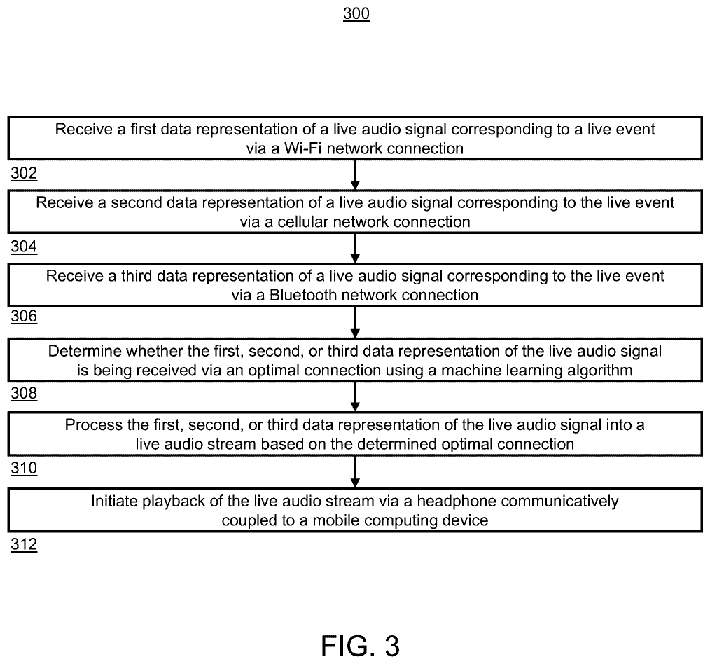

FIG. 3 is a schematic flow diagram illustrating a process 300 for load balancing of real-time delivery of live event data over wireless networks using system 200, according to an illustrative embodiment of the invention. Process 30 begins by receiving, by a first mobile computing device 102 at a live event, a first data representation of a live audio signal corresponding to the live event via a Wi-Fi® network connection 226 at step 302. Process 300 continues by receiving, by the first mobile computing device 102 at the live event, a second data representation of the live audio signal corresponding to the live event via a cellular network connection 236 at step 304. Process 300 continues by receiving, by the first mobile computing device 102 at the live event, a third data representation of the live audio signal corresponding to the live event from a second mobile computing device 102 at the live event via a Bluetooth® connection 246 at step 306.

In some embodiments, process 300 further includes receiving, by the first mobile computing device 102 at the live event, the first data representation of the live audio signal corresponding to the live event from an audio server computing device 104 via the Wi-Fi® network connection 226. In some embodiments, process 300 further includes receiving, by the first mobile computing device 102 at the live event, the second data representation of the live audio signal corresponding to the live event from an audio server computing device 104 via the cellular network connection 236.

Process 300 continues by determining, by the first mobile computing device 102 at the live event, whether the first data representation of the live audio signal, the second data representation of the live audio signal, or the third data representation of the live audio signal is being received via an optimal connection using a machine learning algorithm at step 308. Process 300 continues by processing, by the first mobile computing device 102 at the live event, the first data representation of the live audio signal, the second data representation of the live audio signal, or the third data representation of the live audio signal into a live audio stream based on the determined optimal connection at step 310.

In some embodiments, receiving, by the first mobile computing device 102 at the live event, the first data representation of the live audio signal corresponding to the live event via the Wi-Fi® network connection 226 is associated with a first latency parameter and a first stability parameter. In some embodiments, receiving, by the first mobile computing device 102 at the live event, the second data representation of the live audio signal corresponding to the live event via the cellular network connection 236 is associated with a second latency parameter and a second stability parameter. In some embodiments, receiving, by the first mobile computing device 102 at the live event, the third data representation of the live audio signal corresponding to the live event from the second mobile computing device 102 at the live event via the Bluetooth® connection 246 is associated with a third latency parameter and a third stability parameter.

For example, in some embodiments, the first stability parameter corresponds to a first number of packets lost during a time period, the second stability parameter corresponds to a second number of packets lost during the time period, and the third stability parameter corresponds to a third number of packets lost during the time period. In some embodiments, determining, by the first mobile computing device 102 at the live event, whether the first data representation of the live audio signal, the second data representation of the live audio signal, or the third data representation of the live audio signal is being received via the optimal connection using the machine learning algorithm is based on the first latency parameter, the first stability parameter, the second latency parameter, the second stability parameter, the third latency parameter, and the third stability parameter.

Process 300 finishes by initiating, by the first mobile computing device 102 at the live event, playback of the live audio stream via a headphone 250 communicatively coupled to the first mobile computing device 102 at the live event at step 312. In some embodiments, process 300 includes initiating, by the first mobile computing device 102 at the live event, playback of the live audio stream via the one or more speakers 112 of the first mobile computing device 102 at the live event.

In some embodiments, the connection analysis and selection process performed by system 100 as described above can comprise one of several different configurations:

1) Server-driven predictive analysis of network connections—in this configuration, each mobile computing device (e.g., device 102) performs a periodic or continuous evaluation of each connection (Wi-Fi®, cellular, and Bluetooth®). In one example, the mobile computing device captures packet loss and jitter on each connection and compares those values to expected rates necessary for a steady data stream. Each mobile device then shares the results with server computing device 106. Based on the connection information received from the mobile devices, the server 106 can direct mobile devices as necessary to connect with different connection types as a primary channel for receiving the live audio signal. For example, if many mobile devices connect to the same Wi-Fi network, it would inherently contribute to degradation of the Wi-Fi network (e.g., speed, packet loss, bandwidth, etc.). Then, as packet loss and jitter begin to increase on the mobile computing devices connected to the Wi-Fi network, the server 106 can direct the next set of mobile computing devices 102 to use a cellular network connection. As can be appreciated, because each cellular carrier owns their own bands, this would happen on a carrier frequency level. Then, as cellular jitter/packet loss exceeds expected rates for a steady data stream, the server 106 can direct subsequent mobile computing devices to use a Bluetooth connection. As should be understood, an advantage of this configuration is that the connection priorities determined at the server 106 can dynamically change as mobile devices connect and disconnect from each network.

2) Device-driven predictive analysis of network connections—this configuration is similar to the server-driven configuration described above, but instead of the server computing device 106 receiving the connection stability/quality information from each mobile computing device 102, the mobile devices 102 themselves can evaluate the connections and decide which connection on which to receive the live audio signal (and/or to switch between connections during receipt of the live audio signal). For example, each mobile computing device 102 can continuously evaluate packet loss/jitter on each connection and determine whether to keep using the connection on which live audio signal packets are being received, or whether to switch to a different connection that may have lower packet loss/jitter. As can be appreciated, this process can constantly run in the background on each mobile device so that the user experiences an uninterrupted listening experience.

3) Simultaneous connections to all networks—in this configuration, each mobile device 102 can receive the live audio signal via all available connections at the same time. As can be appreciated, in some embodiments the server computing device 106 generates a single packet with a unique audio frame and the unique frame is then cloned and sent to mobile computing devices 102 via all connections (Wi-Fi®, cellular, Bluetooth®). Each mobile device 102 can listen on each connection and simply discard duplicate audio frames as they arrive. This configuration allows the mobile computing device 102 to be resilient to jitter or stability issues because the device processes the first copy of each unique audio frame that it receives. It should be appreciated, however, that this configuration may result in more noise being generated on the different communication networks. Depending upon the size of the live event, the additional noise may not negatively impact the listening experience.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), a private IP network, an IP private branch exchange (IPBX), a wireless network (e.g., radio access network (RAN), Bluetooth®, near field communications (NFC) network, Wi-Fi®, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

While the invention has been particularly shown and described with reference to specific preferred embodiments, it should be understood by those skilled in the art that various changes in form and detail may be made therein without departing from the spirit and scope of the invention as defined by the following claims. One skilled in the art will realize the subject matter may be embodied in other specific forms without departing from the spirit or essential characteristics thereof. The foregoing embodiments are therefore to be considered in all respects illustrative rather than limiting the subject matter described herein.

1. A computerized method for real-time delivery of live event data over a plurality of wireless networks based on a machine learning algorithm, the method comprising:
receiving, by a first mobile computing device at a live event, a first data representation of a live audio signal corresponding to the live event via a Wi-Fi network connection;
receiving, by the first mobile computing device at the live event, a second data representation of the live audio signal corresponding to the live event via a cellular network connection;
receiving, by the first mobile computing device at the live event, a third data representation of the live audio signal corresponding to the live event from a second mobile computing device at the live event via a Bluetooth connection;
determining, by the first mobile computing device at the live event, whether the first data representation of the live audio signal, the second data representation of the live audio signal, or the third data representation of the live audio signal is being received via an optimal connection using a machine learning algorithm;
processing, by the first mobile computing device at the live event, the first data representation of the live audio signal, the second data representation of the live audio signal, or the third data representation of the live audio signal into a live audio stream based on the determined optimal connection; and
initiating, by the first mobile computing device at the live event, playback of the live audio stream via a headphone communicatively coupled to the first mobile computing device at the live event.

2. The computerized method of claim 1, further comprising:
receiving, by the first mobile computing device at the live event, the first data representation of the live audio signal corresponding to the live event from an audio server computing device via the Wi-Fi network connection.

3. The computerized method of claim 1, further comprising:
receiving, by the first mobile computing device at the live event, the second data representation of the live audio signal corresponding to the live event from an audio server computing device via the cellular network connection.

4. The computerized method of claim 1, wherein:
receiving, by the first mobile computing device at the live event, the first data representation of the live audio signal corresponding to the live event via the Wi-Fi network connection is associated with a first latency parameter and a first stability parameter;
receiving, by the first mobile computing device at the live event, the second data representation of the live audio signal corresponding to the live event via the cellular network connection is associated with a second latency parameter and a second stability parameter; and
receiving, by the first mobile computing device at the live event, the third data representation of the live audio signal corresponding to the live event from the second mobile computing device at the live event via the Bluetooth connection is associated with a third latency parameter and a third stability parameter.

5. The computerized method of claim 4, wherein the first stability parameter corresponds to a first number of packets lost during a time period, the second stability parameter corresponds to a second number of packets lost during the time period, and the third stability parameter corresponds to a third number of packets lost during the time period.

6. The computerized method of claim 4, wherein determining, by the first mobile computing device at the live event, whether the first data representation of the live audio signal, the second data representation of the live audio signal, or the third data representation of the live audio signal is being received via the optimal connection using the machine learning algorithm is based on the first latency parameter, the first stability parameter, the second latency parameter, the second stability parameter, the third latency parameter, and the third stability parameter.

7. A first mobile computing device at a live event for real-time delivery of live event data over a plurality of wireless networks based on a machine learning algorithm, the first mobile computing device at the live event configured to:
receive a first data representation of a live audio signal corresponding to the live event via a Wi-Fi network connection;
receive a second data representation of the live audio signal corresponding to the live event via a cellular network connection;
receive a third data representation of the live audio signal corresponding to the live event from a second mobile computing device at the live event via a Bluetooth connection;
determine whether the first data representation of the live audio signal, the second data representation of the live audio signal, or the third data representation of the live audio signal is being received via an optimal connection using a machine learning algorithm;
process the first data representation of the live audio signal, the second data representation of the live audio signal, or the third data representation of the live audio signal into a live audio stream based on the determined optimal connection; and
initiate playback of the live audio stream via a headphone communicatively coupled to the first mobile computing device at the live event.

8. The first mobile computing device at the live event of claim 7, further configured to:
receive the first data representation of the live audio signal corresponding to the live event from an audio server computing device via the Wi-Fi network connection.

9. The first mobile computing device at the live event of claim 7, further configured to:
receive the second data representation of the live audio signal corresponding to the live event from an audio server computing device via the cellular network connection.

10. The first mobile computing device at the live event of claim 7, wherein:
receiving, by the first mobile computing device at the live event, the first data representation of the live audio signal corresponding to the live event via the Wi-Fi network connection is associated with a first latency parameter and a first stability parameter;
receiving, by the first mobile computing device at the live event, the second data representation of the live audio signal corresponding to the live event via the cellular network connection is associated with a second latency parameter and a second stability parameter; and
receiving, by the first mobile computing device at the live event, the third data representation of the live audio signal corresponding to the live event from the second mobile computing device at the live event via the Bluetooth connection is associated with a third latency parameter and a third stability parameter.

11. The first mobile computing device at the live event of claim 10, wherein the first stability parameter corresponds to a first number of packets lost during a time period, the second stability parameter corresponds to a second number of packets lost during the time period, and the third stability parameter corresponds to a third number of packets lost during the time period.

12. The first mobile computing device at the live event of claim 10, wherein determining, by the first mobile computing device at the live event, whether the first data representation of the live audio signal, the second data representation of the live audio signal, or the third data representation of the live audio signal is being received via the optimal connection using the machine learning algorithm is based on the first latency parameter, the first stability parameter, the second latency parameter, the second stability parameter, the third latency parameter, and the third stability parameter.

13. A system for real-time delivery of live event data over a plurality of wireless networks based on a machine learning algorithm, the system comprising:
a first mobile computing device at a live event communicatively coupled to a second mobile computing device at the live event and an audio server computing device over a Bluetooth network, a Wi-Fi network, or a cellular network, the first mobile computing device at the live event configured to:
receive a first data representation of a live audio signal corresponding to the live event via a Wi-Fi network connection;
receive a second data representation of the live audio signal corresponding to the live event via a cellular network connection;
receive a third data representation of the live audio signal corresponding to the live event from the second mobile computing device at the live event via a Bluetooth connection;
determine whether the first data representation of the live audio signal, the second data representation of the live audio signal, or the third data representation of the live audio signal is being received via an optimal connection using a machine learning algorithm;
process the first data representation of the live audio signal, the second data representation of the live audio signal, or the third data representation of the live audio signal into a live audio stream based on the determined optimal connection; and
initiate playback of the live audio stream via a headphone communicatively coupled to the first mobile computing device at the live event.

14. The system of claim 13, wherein the first mobile computing device is further configured to:
receive the first data representation of the live audio signal corresponding to the live event from the audio server computing device via the Wi-Fi network connection.

15. The system of claim 13, wherein the first mobile computing device is further configured to:
receive the second data representation of the live audio signal corresponding to the live event from the audio server computing device via the cellular network connection.

16. The system of claim 13, wherein:
receiving, by the first mobile computing device at the live event, the first data representation of the live audio signal corresponding to the live event via the Wi-Fi network connection is associated with a first latency parameter and a first stability parameter;
receiving, by the first mobile computing device at the live event, the second data representation of the live audio signal corresponding to the live event via the cellular network connection is associated with a second latency parameter and a second stability parameter; and
receiving, by the first mobile computing device at the live event, the third data representation of the live audio signal corresponding to the live event from the second mobile computing device at the live event via the Bluetooth connection is associated with a third latency parameter and a third stability parameter.

17. The system of claim 16, wherein the first stability parameter corresponds to a first number of packets lost during a time period, the second stability parameter corresponds to a second number of packets lost during the time period, and the third stability parameter corresponds to a third number of packets lost during the time period.

18. The system of claim 16, wherein determining, by the first mobile computing device at the live event, whether the first data representation of the live audio signal, the second data representation of the live audio signal, or the third data representation of the live audio signal is being received via the optimal connection using the machine learning algorithm is based on the first latency parameter, the first stability parameter, the second latency parameter, the second stability parameter, the third latency parameter, and the third stability parameter.

19. The system of claim 13, wherein the second mobile computing device is configured to:
receive the third data representation of the live audio signal corresponding to the live event from the audio server computing device via the Wi-Fi network connection.

20. The system of claim 13, wherein the second mobile computing device is configured to:
receive the third data representation of the live audio signal corresponding to the live event from the audio server computing device via the cellular network connection.
